(19) United States
(12) Patent Application Publication
(10) Pub. No.: US 2016/0353043 A1
(43) Pub. Date: Dec. 1, 2016

(54) IMAGE SENSOR AND IMAGE APPARATUS

(71) Applicant: CANON KABUSHIKI KAISHA, Tokyo (JP)

(72) Inventor: Takafumi Kishi, Yokohama-shi (JP)

(21) Appl. No.: 15/162,348

(22) Filed: May 23, 2016

(30) Foreign Application Priority Data
May 29, 2015 (JP) 2015-109422

(51) Int. Cl. H04N 5/378

(52) U.S. Cl. CPC H04N 5/378

(57) ABSTRACT

A plurality of first pixels each including two or more photoelectric converters and a plurality of second pixels each including one or more photoelectric converters smaller in number than the photoelectric converters in each first pixel are disposed alternately in a row direction and in a column direction.

### BACKGROUND OF THE INVENTION

Field of the Invention

The present disclosure relates to at least one image sensor, at least one image apparatus, one or more methods for using same and one or more mediums for use with same.

Description of the Related Art

There is known in the related art a configuration for focus detection using phase difference from signals from two photodiodes (hereinafter abbreviated as “PD”) in which the two photodiodes are provided for each microlens corresponding to one of the pixels of an image sensor, and the individual PDs receive light in different pupil areas of an imaging lens (Japanese Patent Laid-Open No. 2013-106194).

This configuration allows appreciation image signals to be generated by adding up a plurality of PD signals. This allows phase-difference focus detection simultaneously with image capture by using an image-capturing image sensor.

### SUMMARY OF THE INVENTION

The present disclosure provides an image sensor including a pixel array in which a plurality of first pixels and a plurality of second pixels are disposed in a row direction and in a column direction, a first line, and a second line. The first pixels each include N photoelectric converters (N is a natural number greater than or equal to 2) and N transfer units that transfer electric charge of the N photoelectric converters to a charge-voltage converter. The second pixels each include M photoelectric converters (M is a natural number smaller than N) and M transfer units that transfer electric charge of the M photoelectric converters to a charge-voltage converter. The first line is configured to supply a driving pulse to the transfer units of the first pixels. The second line is configured to supply a driving pulse to the transfer units of the second pixels. In one or more embodiments, the first line is shared by the first pixels disposed in two continuous rows. In one or more embodiments, the second line is shared by the second pixels disposed in two continuous rows.

According to other aspects of the present disclosure, one or more additional image sensors, one or more additional image apparatuses, one or more methods for driving or using same and one or more mediums are discussed herein. Further features of the present disclosure will become apparent from the following description of exemplary embodiments with reference to the attached drawings.

### BRIEF DESCRIPTION OF THE DRAWINGS

FIG. 1 is a block diagram of an image apparatus according to an embodiment of the present disclosure.

FIG. 2 is a schematic diagram of an image sensor according to an embodiment of the present disclosure.

FIG. 3A is a schematic diagram illustrating the configuration of a pixel of the image sensor.

FIG. 3B is a schematic diagram illustrating the configuration of a pixel of the image sensor.

FIG. 4 is a diagram schematically illustrating part of a pixel array.

FIG. 5 is an equivalent circuit diagram illustrating a circuit configuration related to pixels constituting the pixel array.

FIG. 6 is a configuration diagram of a reading circuit.

FIG. 7 is a timing chart illustrating a driving pattern.

FIG. 8 is a first layout chart schematically illustrating the positional relationship among driving lines.

FIG. 9 is a second layout chart schematically illustrating the positional relationship among the driving lines.

FIG. 10 is a third layout chart schematically illustrating the positional relationship among the driving lines.

FIG. 11 is a fourth layout chart schematically illustrating the positional relationship among the driving lines.

### DESCRIPTION OF THE EMBODIMENTS

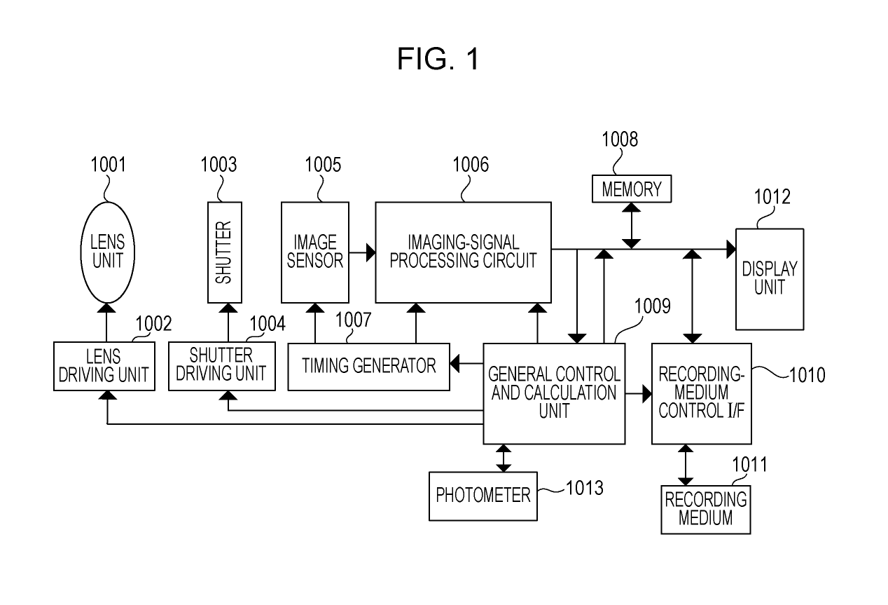

Embodiments of the present disclosure will be described hereinbelow with reference to the drawings. FIG. 1 is a block diagram of a digital camera, which is an image apparatus according to an embodiment.

In FIG. 1, a lens unit 1001 forms an optical image of an object on an image sensor 1005. A lens driving unit 1002 controls zooming, focusing, and the diaphragm of the lens unit 1001. A mechanical shutter 1003 is controlled by a shutter driving unit 1004 and blocks light to the image sensor 1005.

The image sensor 1005 acquires the optical image of the object formed with the lens unit 1001 as an image signal. The detailed configuration of the image sensor 1005 will be described later. An imaging-signal processing circuit 1006 performs various correction processes and a data compression process on the image signal output from the image sensor 1005. The imaging-signal processing circuit 1006 includes a range finding calculation circuit for calculating a defocus amount from a phase-difference signal output from the image sensor 1005.

A timing generator circuit 1007 outputs various timing signals to the image sensor 1005 and the imaging-signal processing circuit 1006. A general control and calculation unit 1009 performs various calculations and controls the entire image apparatus. A memory 1008 temporarily stores image data and so on.

A recording-medium control interface 1010 records and reads image data on and from a removable recording medium 1011, such as a semiconductor memory. A display unit 1012 displays various pieces of information and captured images. A photometer unit 1013 measures the luminance of the object to determine an exposure during image capture.

Next, the operation of the digital camera will be described. When a main power supply (not shown) is turned on by an operator, components of the digital camera are supplied with electric power. When a release button (not shown) is pressed by the operator, the range finding calculation circuit of the imaging-signal processing circuit 1006 calculates a defocus amount (the amount of image shift of the object) from a phase-difference signal output from the image sensor 1005.

Thereafter, the lens unit 1001 is driven with the lens driving unit 1002. It is determined whether the object is in focus. If it is determined that the object is out of focus, the lens unit 1001 is driven again, and the defocusing amount is calculated. After an in-focus state is confirmed, an imaging operation is started.

Image data output from the image sensor 1005 is subjected to various image processing operations with the imaging-signal processing circuit 1006 and is written to the memory 1008 under the control of the general control and calculation unit 1009. The imaging-signal processing circuit 1006 performs sorting of the image data and adding of the image data. The image data written to the memory 1008 is recorded on the recording medium 1011 via the recording medium control I/F 1010 under the control of the general control and calculation unit 1009.

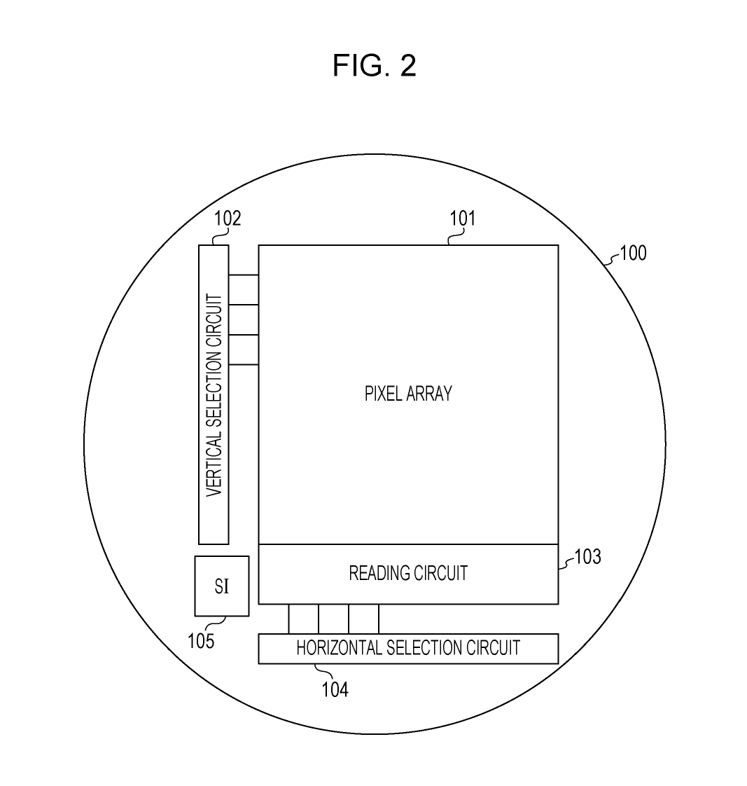

FIG. 2 is a schematic diagram of an image sensor 100 according to an embodiment of the present disclosure. In FIG. 2, the image sensor 100 includes a pixel array 101 in which a plurality of pixels are arrayed in two dimensions, a vertical selection circuit 102 for selecting a pixel row in the pixel array 101, and a horizontal selection circuit 104 for selecting a pixel column in the pixel array 101. The image sensor 100 further includes a reading circuit 103 for reading signals from pixels in a pixel row selected from the plurality of pixels in the pixel array 101 by the vertical selection circuit 102 and a serial interface (SI) 105 for determining the operation modes of the individual circuits from the outside.

In addition to the illustrated components, the image sensor 100 includes a control circuit and a timing generator that generates timing signals for the vertical selection circuit 102, the horizontal selection circuit 104, and the reading circuit 103.

The vertical selection circuit 102 selects the plurality of pixel rows of the pixel array 101 in sequence and reads signals from pixels in the selected pixel row to the reading circuit 103. The horizontal selection circuit 104 sequentially selects pixel signals read from the individual pixel rows to the reading circuit 103 and outputs the pixel signals outside the image sensor 100.

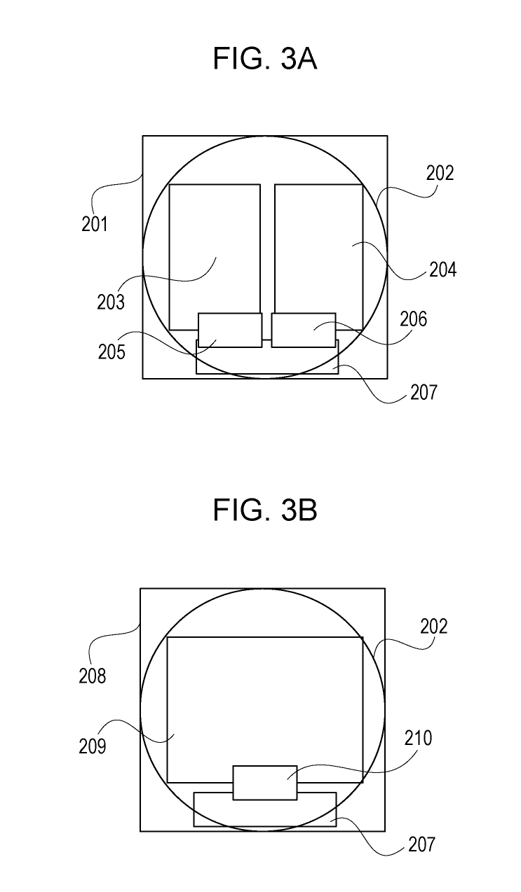

FIGS. 3A and 3B are schematic diagrams illustrating the configurations of pixels of the image sensor 100 according to at least the embodiment of FIG. 2 of the present disclosure. FIG. 3A illustrates a first pixel 201 that performs phase-difference detection and image capture.

The first pixel 201 includes a microlens 202, two photodiodes (hereinafter abbreviated as “PDs”) 203 and 204, and a floating diffusion (hereinafter abbreviated as “FD”) 207 that temporarily stores electric charges generated in the PDs 203 and 204. The first pixel 201 further includes transfer switches 205 and 206 serving as transfer units that transfer the electric charges in the PDs 203 and 204 to the FD 207. The FD 207 functions as a charge-voltage converter, described later. In addition to the illustrated components, at least one embodiment of the first pixel 201 includes a plurality of components described later. The FD 207 functions also as an electric-charge holding unit that holds the electric charges transferred from the PDs 203 and 204. The first pixel 201 may further include an electric-charge holding unit for a global shutter, which temporarily holds electric charges.

FIG. 3B illustrates a second pixel 208 that performs only image capture without performing phase-difference detection. The second pixel 208 includes a microlens 202, a single PD 209, an FD 207 that temporarily stores electric charge generated in the PD 209, and a transfer switch 210 that transfers the electric charge of the PD 209 to the FD 207. The difference between the first pixel 201 that performs both phase-difference detection and image capture and the second pixel 208 that performs only image capture is whether a single pixel includes two PDs and two transfer switches corresponding the PDs.

The PDs 203 and 204 of the first pixel 201 that performs both phase-difference detection and image capture receive lights in different pupil areas of the imaging lens via the microlens 202. For this reason, reading a signal from the PD 203 and a signal from the PD 204 separately and comparing the signals allows an out-of-focus state of the imaging lens to be detected using a phase-difference detection technique. Since the phase-difference detection technique is a known art, as is disclosed in Japanese Patent Laid-Open No. 2013-106194, a detailed description will be omitted.

By combining the signal from the PD 203 and the signal from the PD 204, a signal of light on an identical pupil area of the imaging lens, like the signal from the PD 209 of the second pixel 208 that performs only image capture, can be acquired. Thus, the signal from the PD 203 and the signal from the PD 204 can be regarded as an imaging signal.

In one or more embodiments, it is only required that the first pixel 201 includes N photoelectric converters, or PDs, (N is a natural number greater than or equal to 2) and N transfer switches, or transfer units, that transfer the electric charges of the N PDs to a FD, or a charge-voltage converter. In one or more embodiments, it is only required that the second pixel 208 includes M photoelectric converters, or PDs, (M is a natural number smaller than N) and M transfer switches, or transfer units, that transfer the electric charges of the M PDs to a FD, or a charge-voltage converter.

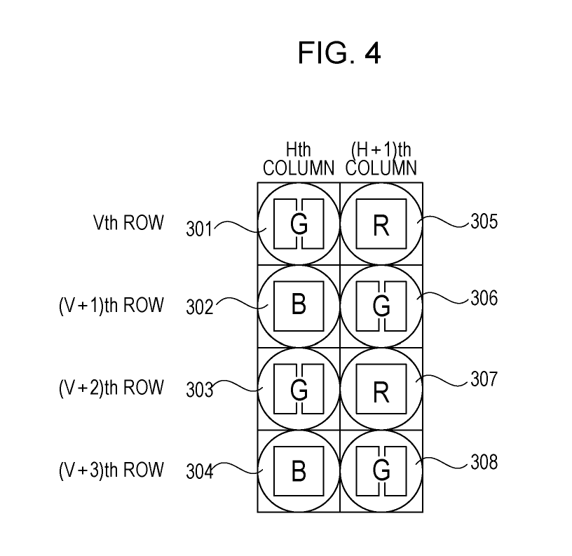

FIG. 4 is a diagram schematically illustrating part of the pixel array 101. In FIG. 4, a pixel 301 is disposed in the Vth row of the Hth column, and a pixel 302 is disposed in the (V+1)th row of the Hth column. This applies also to the other pixels, indicating what column and what row they are disposed in. While FIG. 4 illustrates a part of a pixel array having four rows and two columns, the pixel array 101 includes more pixels to provide a two-dimensional image. Although in this embodiment the pixels are disposed in a horizontal direction, the pixels may be disposed in another pattern. For example, a disposition in which the pixels are disposed at 45 degrees with respect to the horizontal direction provides the same advantageous effects as those of this embodiment.

Pixels 301, 303, 306, and 308 correspond to the first pixel 201 that performs both phase-difference detection and image capture, described in FIG. 3A, and pixels 302, 304, 305, and 307 correspond to the second pixel 208 that performs only image capture, described in FIG. 3B. In other words, the first pixels 201 and the second pixels 208 are mixedly and alternately disposed in the row direction and the column direction to form a pixel array. The first pixels and the second pixels each include a microlens.

In at least one embodiment, the pixels 301, 303, 306, and 308, or the first pixels, each include a G filter, which is a color filter that mainly transmits green light. In at least one embodiment, the pixels 302 and 304, or the second pixels, each include a B filter, which is a color filter that mainly transmits blue light. In at least one embodiment, the pixels 305 and 307, or the second pixels, each include an R filter, which is a color filter that mainly transmits red light. In other words, in at least one embodiment, the first pixels and the second pixels include color filters with different spectral transmittances.

By regularly disposing the color filters that mainly transmit light with different wavelengths in units of two rows and two columns (Bayer pixel arrangement) in this manner, a color image can be captured.

In this embodiment, the pixels that perform both phase-difference detection and image capture are each provided with a G filter. This is because the G filter has higher sensitivity than the R filter and the B filter. For this reason, to enhance the accuracy of phase-difference detection, pixels that perform both phase-difference detection and image capture are provided with the G filters.

The present disclosure is not limited to the above configuration. In some embodiments, the pixels 301 and 303 are provided with the R filters, the pixels 306 and 308 are provided with the B filters, and the pixels 302, 304, 305, and 307 are provided with the G filters. In other words, all of pixels that perform phase-difference detection are provided with the G filters, or all of pixels that perform only image capture are provided with the G filters so that the pixels in which the G filters are disposed have the same pixel configuration.

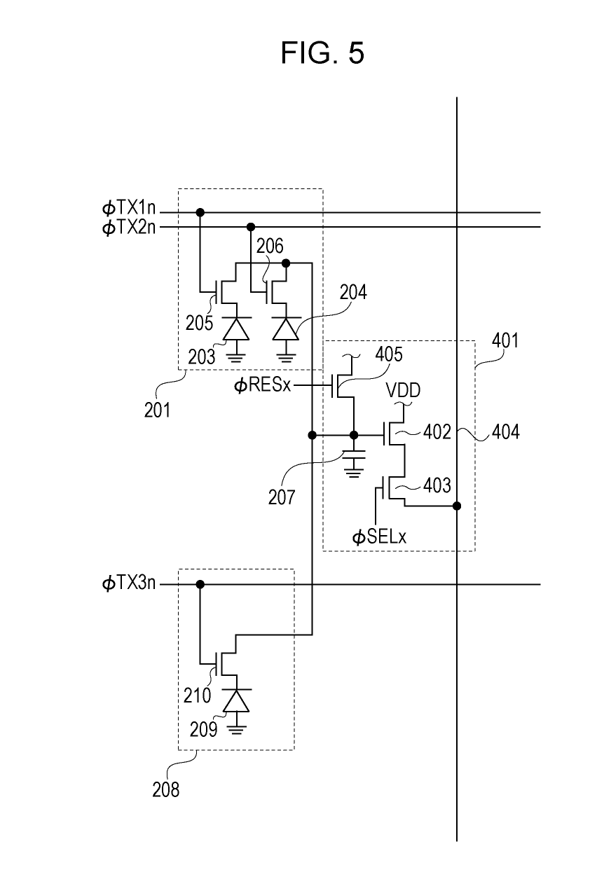

FIG. 5 is an equivalent circuit diagram illustrating a circuit configuration related to the pixels in FIGS. 3A and 3B. FIG. 5 schematically illustrates the circuit configuration of pixels in two rows of one column. In FIG. 5, the first pixel 201 that performs both phase-difference detection and image capture is disposed in the first row, and the second pixel 208 that performs only image capture is disposed in the second row. An output unit 401 for reading signals from the individual pixels is shared by the first pixel 201 and the second pixel 208. Sharing the output unit 401 between the two pixels, e.g., the first pixel 201 and the second pixel 208, reduces the number of circuits in the pixel array and increases the aperture ratio and the areas of the PDs 203, 204, and 209, that is, the amount of saturated electric charge.

The transfer switches 205, 206, and 210 are respectively driven by transfer pulses φTX1n, φTX2n, and φTX3n and transfer photocharges generated in the PDs 203, 204, and 209 to the FD 207. The FD 207 serves as a buffer that temporarily stores the electric charges transferred from the PDs 203, 204, and 209. An amplifying MOS amplifier 402 functions as a source follower. A selection switch 403 is driven by a selection pulse φSELx to select a pixel from which a signal is to be read.

The FD 207, the amplifying MOS amplifier 402, and a constant current source (not shown) constitute a floating diffusion amplifier. A voltage signal according to the amount of electric charge of the FD 207 is output from a pixel selected by the selection switch 403 to a columnar output line 404 and is read by the reading circuit 103.

A reset switch 405 resets the FD 207 with a constant voltage source VDD in response to a reset pulse φRESx. Subscripts n and x in the transfer pulses φTX1n, φTX2n, φTX3n, the selection pulse φSELx, and the reset pulse φRESx individually indicate the order of driving. The switches are driven in sequence until signals of all the pixels are read in the row direction.

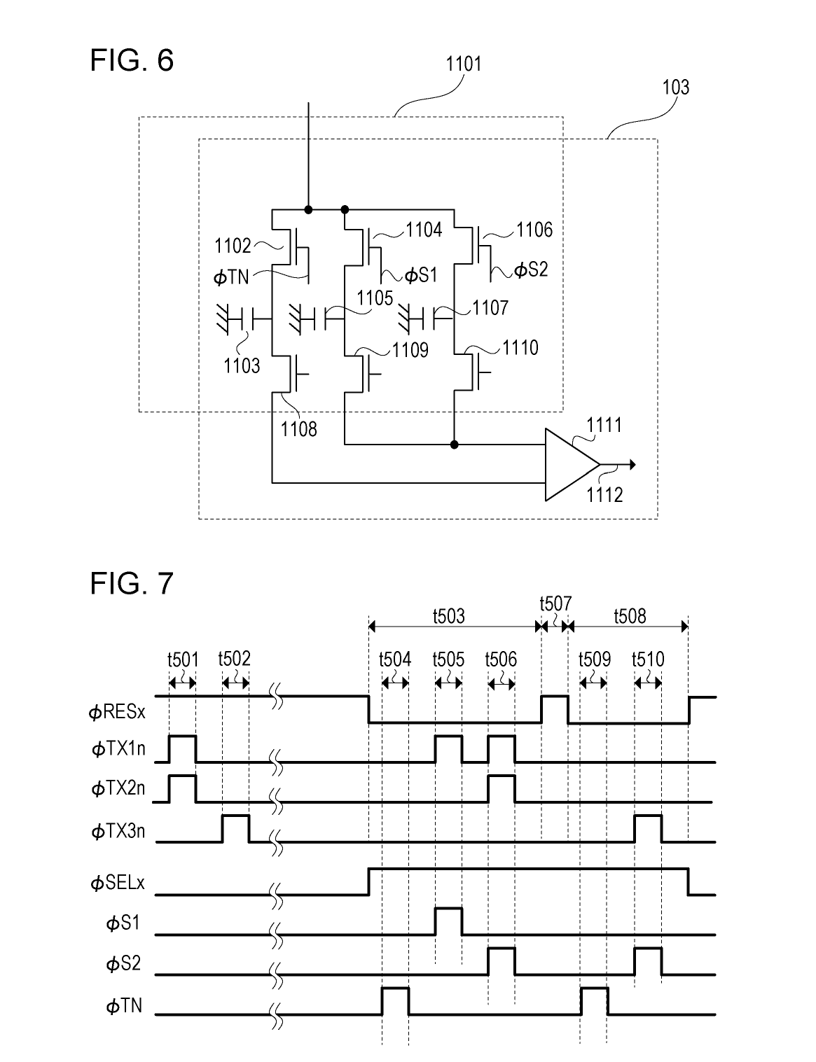

FIG. 6 is a configuration diagram of the reading circuit 103 provided for each pixel column. A column circuit 1101 is provided for each pixel column, into which signals from the pixels of the individual pixel columns are read. Although this example illustrates only one column, the reading circuit 103 is disposed for each pixel column.

The ON/OFF state of a switch 1102 is controlled by a transfer pulse φTN and holds a reset signal corresponding to a potential at cancellation of the reset of the FD 207, which is read through the columnar output line 404, in a capacitor 1103.

The ON/OFF state of a switch 1104 is controlled by a transfer pulse φS1 and holds a first PD signal in which a reset signal is included in an imaging signal of the PD 203, which is read through the columnar output line 404, in a capacitor 1105.

The ON/OFF state of a switch 1106 is controlled by a transfer pulse φS2 and holds a second PD signal in which a reset signal is added to an imaging signal of the PD 203 and an imaging signal of the PD 204, which are read through the columnar output line 404, in a capacitor 1107.

The signals held in the capacitors 1103, 1105, and 1107 are respectively read in a read amplifier 1111 via switches 1108, 1109, and 1110.

When the switches 1109 and 1108 are turned on, the read amplifier 1111 amplifies the difference between the first PD signal held in the capacitor 1105 and the reset signal held in the capacitor 1103 and outputs the imaging signal of the PD 203 to an external output signal line 1112.

When the switches 1110 and 1108 are turned on, the read amplifier 1111 amplifies the difference between the second PD signal held in the capacitor 1107 and the reset signal held in the capacitor 1103 and outputs a signal in which the imaging signal of the PD 204 is added to the imaging signal of the PD 203 to the external output signal line 1112.

The column circuit 1101 may further include a gain amplifier and an analog-to-digital (AD) converter for each column.

Next, a method for driving a solid-state image sensor with the above configuration will be described. FIG. 7 is a timing chart illustrating a driving pattern for reading signals in two rows into the reading circuit 103.

First at time t501, the transfer pulses φTX1n and φTX2n are raised to High level at the same time while the reset pulse φRESx is held at a high potential (hereinafter referred to as High level). This causes the transfer switches 205 and 206 to be turned on while the reset switch 405 is ON. The potentials of the FD 207 and the PDs 203 and 204 are reset to initial potentials by the constant voltage source VDD. Thereafter, the transfer pulses φTX1n and φTX2n are dropped to low potentials (hereinafter referred to as Low level) to start to accumulate electric charges in the PDs 203 and 204.

Likewise, at time t502, the transfer pulse φTX3n is raised to High level, with the reset pulse φRESx held at High level. This causes the transfer switch 210 to be turned on while the reset switch 405 is ON, and the potentials of the FD 207 and the PD 209 are reset to initial potentials by the constant voltage source VDD. Thereafter, the transfer pulse φTX3n is dropped to Low level to start to accumulate electric charges in the PD 209.

Since the PDs 203 and 204 and the PD 209 are in different rows, and signals are read at different timings, the reset is also performed at different timings, as described above, to start the charge accumulation at the same time.

Next, at time t503 after a predetermined time, which depends on the charge accumulation time, the selection pulse φSELx is raised to High level to turn on the selection switch 403 to thereby select a row to be read, and an operation of reading signals of one row is started. At time t503, the reset pulse φRESx is dropped to Low level to cancel the reset of the FD 207. Pixels from which signals are to be read at time t503 are the first pixels 201 that perform both phase-difference detection and image capture.

At time t504, the transfer pulse φTN is raised to High level to turn on the switch 1102. A reset signal corresponding to the potential of the FD 207 at the cancellation of the reset is read in the capacitor 1103 of the column circuit 1101 for storage.

At time t505, the transfer pulse φTX1n and the transfer pulse φS1 are raised to High level at the same time to turn on the transfer switch 205 and the switch 1104 at the same time. The first PD signal in which a reset signal is included in the imaging signal, or the photoelectric conversion signal, of the PD 203 is read in the capacitor 1105 for storage.

At time t506, the transfer pulses φTX1n and φTX2n and the transfer pulse φS2 are raised to High level at the same time to turn on the transfer switches 205 and 206 and the switch 1106 at the same time. The second PD signal in which a reset signal is included in a signal, in which the imaging signal of the PD 203 and the imaging signal of the PD 204 are added up, is read in the capacitor 1107 for storage.

The transfer pulse φTX1n may be kept at Low level at time t506 because the transfer pulse φTX1n is set to High level at time t505 to turn on the transfer switch 205 to transfer the electric charge of the PD 203 to the FD 207. The period from the end of time t501 to the end of time t506 described above is charge accumulation time.

Thus, the ON/OFF states of the switches 1108, 1109, and 1110 are controlled by the horizontal selection circuit 104. The reset signal held in the capacitor 1103, the first PD signal held in the capacitor 1105 of the column circuit 1101, and the second PD signal held in the capacitor 1107 in the column circuit 1101 are output outside the image sensor via the read amplifier 1111.

First, by turning on the switches 1109 and 1108, the difference between the first PD signal held in the capacitor 1105 and the reset signal held in the capacitor 1103 is amplified with the read amplifier 1111, and an A-image signal, which is the imaging signal of the PD 203, is output to the external output signal line 1112.

By turning on the switches 1110 and 1108, the difference between the second PD signal held in the capacitor 1107 and the reset signal held in the capacitor 1103 is amplified with the read amplifier 1111, and an (A+B) image signal in which the A-image signal, which is the imaging signal of the PD 203, and a B-image signal, which is the imaging signal of the PD 204, are added up is output to the external output signal line 1112.

Since the (A+B)-image signal is a signal in which the A-image signal, which is the imaging signal of the PD 203, and the B-image signal, which is the imaging signal of the PD 204, are combined, the B-image signal, which is the imaging signal of the PD 204, is generated by subtracting the A-image signal from the (A+B)-image signal with the imaging-signal processing circuit 1006 or the like.

At time t507, the FD 207 is reset by setting the reset pulse φRESx to High level to turn on the reset switch 405 in preparation for reading the signal of the next pixel.

At time t508, the reset pulse φRESx is dropped to Low level to cancel the reset of the FD 207. Pixels from which signals are read at time t508 are the second pixels 208 that perform only image capture.

At time t509, the transfer pulse φTN is raised to High level to turn on the switch 1102 to read a reset signal corresponding to the potential of the FD 207 at cancellation of the reset in the capacitor 1103 of the column circuit 1101 for storage.

At time t510, the transfer pulse φTX3n and the transfer pulse φS2 are raised to High level at the same time to turn on the transfer switch 210 and the switch 1106 at the same time, and a third PD signal in which a reset signal is included in an imaging signal, which is the photoelectric conversion signal, of the PD 209 to the capacitor 1107 for storage.

As described above, the ON/OFF states of the switches 1108 and 1110 are controlled by the horizontal selection circuit 104. Thus, the reset signal held in the capacitor 1103 and the third PD signal held in the capacitor 1107 of the column circuit 1101 are output outside the image sensor via the read amplifier 1111.

By turning on the switches 1110 and 1108, the difference between the third PD signal held in the capacitor 1107 and the reset signal held in the capacitor 1103 is amplified by the read amplifier 1111. The imaging signal of the PD 209 is output to the external output signal line 1112.

In reading a signal from the second pixel 208 that performs only image capture, the time for reading the first PD signal for phase-difference detection is not needed. Consequently, separately driving the first pixel 201 that performs both phase-difference detection and image capture and the second pixel 208 that performs only image capture allows high-speed reading of the signal of the second pixel 208 that performs only image capture.

As shown in FIG. 4, since the first pixels 201 that perform both phase-difference detection and image capture and the second pixels 208 that perform only image capture are driven in units of two rows of two columns in the same way, and the first pixels 201 are provided with the same color G, no noise difference is caused by difference in driving among rows.

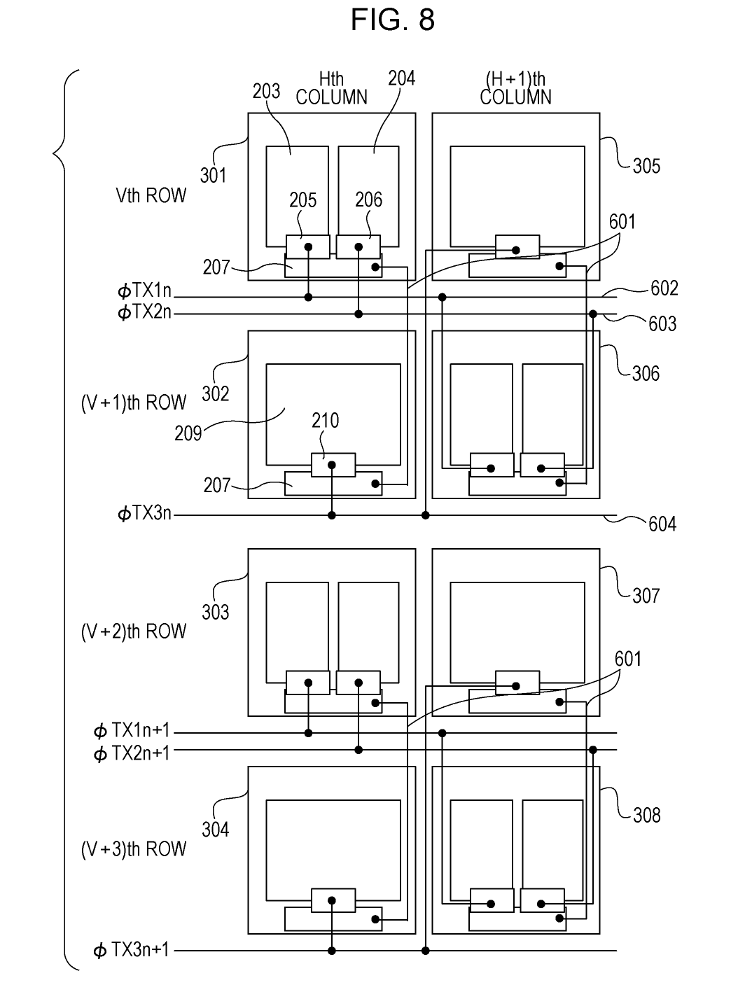

FIG. 8 is a first layout chart schematically illustrating the positional relationship among lines for supplying driving pulses for the pixels 301 to 308 shown in FIG. 4. For the driving shown in FIG. 7, the first pixels 201 that perform both phase-difference detection and image capture and the second pixels 208 that perform only image capture need to be driven at different times.

However, since the first pixels 201 and the second pixels 208 are mixed in the identical row, the identical row cannot be driven at the same time. For this reason, a line supplied with driving pulses for the individual pixels is shared by two continuous rows, as shown in FIG. 8, so that signals of the first pixels 201 and signals of the second pixel 208 are read by driving the two continuous rows.

A line 601 interconnects FDs 207 of two vertically adjacent pixels. The pixel 301 and the pixel 306 are the first pixels 201 that perform both phase-difference detection and image capture, to which the transfer pulse φTX1n and the transfer pulse φTX2n are supplied through the same first lines 602 and 603. The pixel 303 and the pixel 308 in a diagonal direction are also the first pixels 201 that perform both phase-difference detection and image capture, to which transfer pulses φTX1n+1 and φTX2n+1 are supplied through the same lines.

The pixel 302 and the pixel 305 are the second pixels 208 that perform only image capture, to which the transfer pulse φTX3n is supplied through an identical second line 604. The pixel 304 and the pixel 307 in a diagonal direction are also the second pixels 208 that perform only image capture, to which a transfer pulse φTX3n+1 is supplied through an identical line. In other words, the first lines 602 and 603 and the second line 604 are shared by pixels disposed next to one another in a diagonal direction.

First, the transfer pulses φTX1n and φTx2n are supplied to read signals from the pixel 301 in the Vth row of the Hth column and the pixel 306 in the (V+1)th row of the (H+1)th column by driving at time t503 in FIG. 7. Subsequently, the transfer pulse φTX3n is supplied to read signals from the pixel 302 in the (V+1)th row of the Hth column and the pixel 305 in the Vth row of the ((H+1) th column by driving at time t508 in FIG. 7.

Upon completion of the reading of signals from the pixels 301, 306, 302, and 305, in the Vth row and the (V+1)th row, the transfer pulses φTX1n+1 and φTx2n+1 are supplied by driving at time t503 in FIG. 7. Then, signals are read from the pixel 303 in the (V+2)th row of the Hth column and the pixel 308 in the (V+3)th row of the (H+1)th column.

Subsequently, the transfer pulse φTX3n is supplied to read signals from the pixel 304 in the (V+3)th row of the Hth column and the pixel 307 in the (V+2)th row of the (H+1)th column.

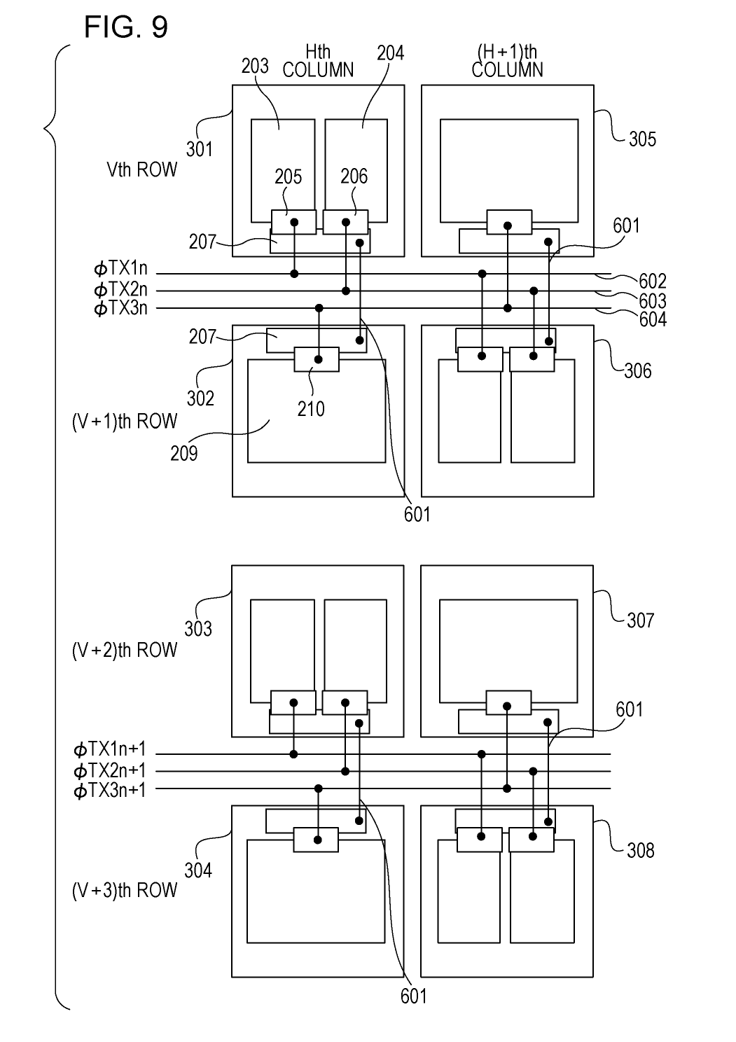

FIG. 9 is a second layout chart schematically illustrating the positional relationship among the driving lines of the pixels 301 to 308 shown in FIG. 4. In the layout in FIG. 8, the FD 207 and the transfer switches 205, 206, and 210 are located in the same direction (below in the drawing) with respect to the PDs 203, 204, and 209. In contrast, in the layout in FIG. 9, the positions of the FD 207 and the transfer switches 205, 206, and 210 differ between the first pixels 201 that perform both phase-difference detection and image capture and the second pixels 208 that perform only image capture.

This disposition decreases the distance between the FDs 207 and the transfer switches 205, 206, and 210 between two pixels that share the signal lines 602 to 604 for supplying driving pulses. This reduces the lengths of the lines 602 to 604 for supplying the transfer pulses φTX1, φTX2, and φTX3 and the length of the line 601 that interconnects the FDs 207, enhancing the area efficiency.

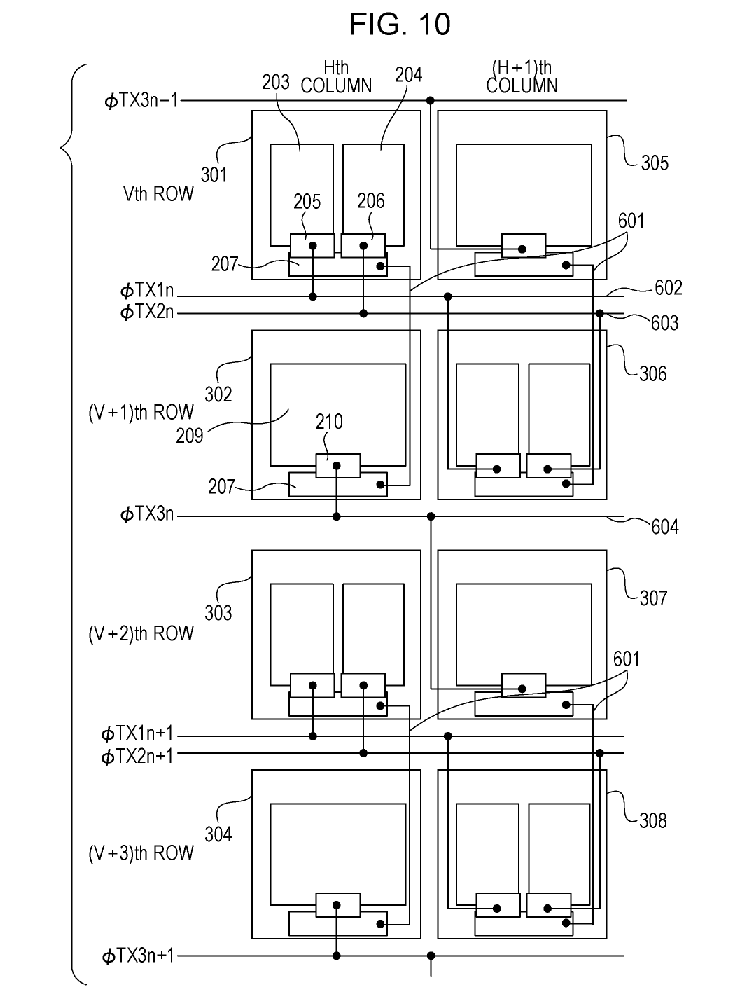

FIG. 10 is a third layout chart schematically illustrating the positional relationship among driving lines for the pixels 301 to 308 shown in FIG. 4. In the layout in FIG. 10, a pixel row driven by the transfer pulses φTX1n and φTX2n and a pixel row driven by the transfer pulse φTX3n differ.

Specifically, pixels driven by the transfer pulses φTX1n and φTX2n are the pixel 301 in the Vth row and the pixel 306 in the (V+1)th row, and pixels driven by the transfer pulse φTX3n are the pixel 302 in the (V+1)th row and the pixel 307 in the (V+2)th row.

Thus, the driving lines for the first pixels 201 that perform both phase-difference detection and image capture and the driving lines for the second pixels 208 that perform only image capture differ, not in the units of two rows. This can decrease the density of pixel lines in the column direction, enhancing the area efficiency.

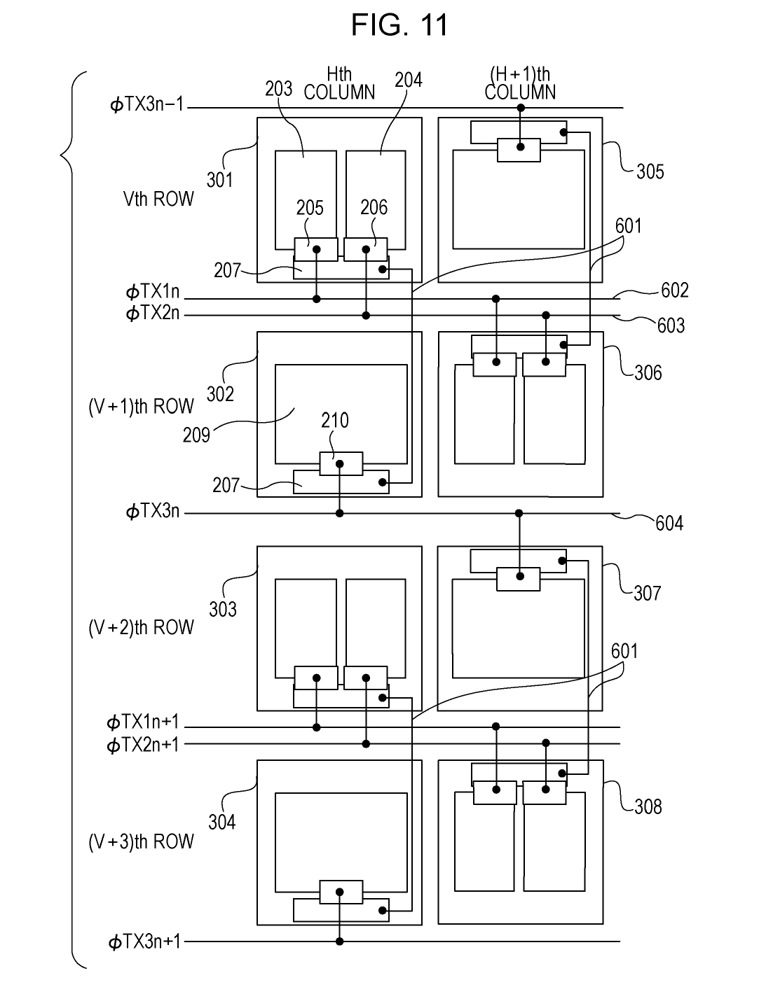

FIG. 11 is a fourth layout chart schematically illustrating the positional relationship among the driving lines for the pixels 301 to 308 shown in FIG. 4. In the layout in FIG. 11, a pixel row driven by the transfer pulses φTX1n and φTX2n and a pixel row driven by the transfer pulse φTX3n differ, as in the layout in FIG. 10.

Furthermore, the positions of the FD 207 and the transfer switches 205, 206, and 210 differ between pixels in adjacent columns (for example, the Hth column and the (H+1)th column). This disposition further decreases the line lengths, enhancing the area efficiency.

As described above, the configuration in which the first pixel 201 that performs both phase-difference detection and image capture and the second pixel 208 that performs only image capture share signal lines 602 to 604 for supplying driving pulses every two rows and the driving shown in FIG. 7 offer the following advantageous effects.

In other words, this reduces, in the configuration in which image capture and phase-difference detection are performed at the same time using an image sensor for image capture, pixel-signal read time to achieve high-speed signal reading without increasing streak noise in imaging signals. Although the FD 207 in this embodiment is shared by two upper and lower pixels, the present disclosure is not limited to this configuration. For example, the FD 207 may be shared by four pixels in the column direction or may be shared by two pixels in the row direction and two pixels in the column direction.

With such pixel dispositions and the driving method, pixel data is not output in sequence from the image sensor 100 every row but is alternately output every two rows and two columns. For use as image signals, the pixel data is sorted in the order of pixels in or out of the image sensor 100 (for example, with the imaging-signal processing circuit 1006). In this case, the imaging-signal processing circuit 1006 corresponds to a sorting unit for sorting the pixel data.

In the pixels that perform both phase-difference detection and image capture, a reset signal is read, and then the first PD signal from (the A-image signal) is read, and the second PD signal is read as an imaging signal (the (A+B)-image signal) in which the first PD signal and the second PD signal are added together. In this way, by reading the (A+B)-image signal after reading the A-image signal without reading a reset signal, the number of times of reading reset signals is reduced, thus achieving high-speed signal reading.

Furthermore, even for pixels capable of both phase-difference detection and image capture, higher-speed signal reading can be achieved by switching between driving for phase-difference detection and driving not for phase-difference detection in a screen. In other words, read driving for phase-difference detection may be performed only for pixel rows for use in focus detection, and read driving not for phase-difference detection may be performed for the other pixel rows.

In this case, for the pixel rows for use in focus detection, reset reading is performed and then a signal from the first PD signal (the A-image signal) is read, and an imaging signal (the (A+B)-image signal), which is a combined signal of the first PD signal and the second PD signal, is read.

For the pixel rows in which no phase-difference detection is performed, an imaging signal (the (A+B)-image signal) is read after reset reading is performed without reading the A-image signal. This increases the signal reading speed for pixel rows other than the pixel rows for use in focus detection, further reducing the signal read time for all rows.

The embodiments of the present disclosure can increase the speed of reading signals for phase-difference detection and image capture using an image sensor without increasing streak noise in the imaging signals.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-109422, filed May 29, 2015, which is hereby incorporated by reference herein in its entirety.

What is claimed is:

1. An image sensor comprising:
a pixel array in which a plurality of first pixels and a plurality of second pixels are disposed in two dimensions, the first pixels each comprising two or more photoelectric converters and a transfer unit that transfers electric charge of the two or more photoelectric converters to an electric-charge holding unit, the second pixels each comprising one or more photoelectric converters smaller in number than the photoelectric converters in each first pixel and a transfer unit that transfers electric charge of the one or more photoelectric converters to an electric-charge holding unit;
a first line configured to supply a driving pulse to the transfer units of the first pixels; and
a second line configured to supply a driving pulse to the transfer units of the second pixels,
wherein the first line is shared by the first pixels disposed in two continuous rows, and the second line is shared by the second pixels disposed in two continuous rows.

2. The image sensor of claim 1, wherein at least one of the two continuous rows in which the first pixels are disposed is included in the two continuous rows in which the second pixels are disposed.

3. The image sensor of claim 1, wherein the first pixels and the second pixels are disposed alternately in a row direction and a column direction in the pixel array.

4. The image sensor of claim 1,
wherein the first pixels and the second pixels in the pixel array each comprise a color filter, the color filters being regularly disposed,
wherein the first pixels and the second pixels comprise color filters with different spectral transmittances, and
wherein the first pixels each further comprises a color filter that transmits green light.

5. The image sensor of claim 1, wherein the first pixels and the second pixels each further comprises a microlens.

6. The image sensor of claim 1, further comprising a reading circuit configured to read signals from the first pixels and signals from the second pixels at different times.

7. The image sensor of claim 1, wherein the first pixels and the second pixels share at least one electric-charge holding unit.

8. The image sensor of claim 1, wherein the first line and the second line are disposed between different pixel rows.

9. The image sensor of claim 8, wherein the first line is shared by the first pixels disposed in two continuous rows that flank the first line, and the second line is shared by the second pixels disposed in two continuous rows that flank the second line.

10. An image sensor comprising:
a pixel array in which a plurality of first pixels and a plurality of second pixels are disposed in two dimensions, the first pixels each comprising two or more photoelectric converters and a transfer unit that transfers electric charge of the two or more photoelectric converters to an electric-charge holding unit, the second pixels each comprising one or more photoelectric converters smaller in number than the photoelectric converters in each first pixel and a transfer unit that transfers electric charge of the one or more photoelectric converters to an electric-charge holding unit;
a first line configured to supply a driving pulse to the transfer units of the first pixels; and
a second line configured to supply a driving pulse to the transfer units of the second pixels,
wherein the first line is shared by the first pixels adjacent in a diagonal direction, and the second line is shared by the second pixels adjacent in a diagonal direction.

11. The image sensor of claim 10, wherein at least one of the two continuous rows in which the first pixels are disposed is included in the two continuous rows in which the second pixels are disposed.

12. The image sensor of claim 10, wherein the first pixels and the second pixels are disposed alternately in a row direction and a column direction in the pixel array.

13. The image sensor of claim 10,
wherein the first pixels and the second pixels in the pixel array each comprise a color filter, the color filters being regularly disposed,
wherein the first pixels and the second pixels comprise color filters with different spectral transmittances, and
wherein the first pixels each further comprises a color filter that transmits green light.

14. The image sensor of claim 10, further comprising a reading circuit configured to read signals from the first pixels and signals from the second pixels at different times.

15. The image sensor of claim 10, wherein the first pixels and the second pixels share at least one electric-charge holding unit.

16. The image sensor of claim 10, wherein the first line and the second line are disposed between different pixel rows.

17. The image sensor of claim 16, wherein the first line is shared by the first pixels disposed in two continuous rows that flank the first line, and the second line is shared by the second pixels disposed in two continuous rows that flank the second line.

18. An image apparatus comprising:
an image sensor comprising:
a pixel array in which a plurality of first pixels and a plurality of second pixels are disposed in two dimensions, the first pixels each comprising two or more photoelectric converters and a transfer unit that transfers electric charge of the two or more photoelectric converters to an electric-charge holding unit, the second pixels each comprising one or more photoelectric converters smaller in number than the photoelectric converters in the first pixel and a transfer unit that transfers electric charge of the one or more photoelectric converters to an electric-charge holding unit;
a first line configured to supply a driving pulse to the transfer units of the first pixels; and
a second line configured to supply a driving pulse to the transfer units of the second pixels,
a signal processing circuit configured to perform predetermined signal processing on a signal output from the image sensor; and
a control unit configured to control the image sensor and the signal processing circuit,
wherein the first line is shared by the first pixels disposed in two continuous rows, and the second line is shared by the second pixels disposed in two continuous rows.

19. The image apparatus of claim 18, wherein signals read from the first pixels are used for focus detection.

20. The image apparatus of claim 18, wherein the signal processing circuit comprises a sorting unit configured to sort signals read from the first pixels and signals read from the second pixels.
